(19) United States
(12) Patent Application Publication
(10) Pub. No.: US 2013/0051751 A1
(43) Pub. Date: Feb. 28, 2013

(54) PARAMETER ANALYZING APPARATUS AND METHOD

(71) Applicants: BING ZHOU, Shenzhen City (CN); DONG-YAN LI, Shenzhen City (CN)

(72) Inventors: BING ZHOU, Shenzhen City (CN); DONG-YAN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/325,527

(22) Filed: Dec. 14, 2011

(30) Foreign Application Priority Data
Aug. 29, 2011 (CN) 201110250837.8

(51) Int. Cl. H04N 5/775

(52) U.S. Cl. 386/230; 386/E05.07

(57) ABSTRACT

A parameter analyzing method for analyzing parameters set in an electronic device, includes step of: displaying a user interface having a plurality of icons to be activated to received user's commands; generating instructions in response to the user's commands; transmitting the instructions to the electronic device; receiving the parameters generated by the electronic device according to the instructions; and detecting whether the received parameters meet a requirement by comparing the received parameters with predetermined parameters.

### BACKGROUND

1. Technical Field

The present disclosure relates to parameter analyzing technology, and particularly to a parameter analyzing apparatus and method.

2. Description of Related Art

During production process of many electronic devices, it is needed to analyze parameters set in the electronic devices. Using a (Blue Ray Disc) BD DVD player as an example, the typical method for analyzing the parameters set in the BD DVD is performed by manually inputting characters (which form instructions) one by one to the BD DVD player so parameters will be obtained from the BD DVD player according to the instructions. This is very inconvenient and time consuming.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a parameter analyzing apparatus.

FIG. 2 is a user interface provided by the parameter analyzing apparatus of FIG. 1.

FIG. 3 is a flow chart of a parameter analyzing method.

### DETAILED DESCRIPTION

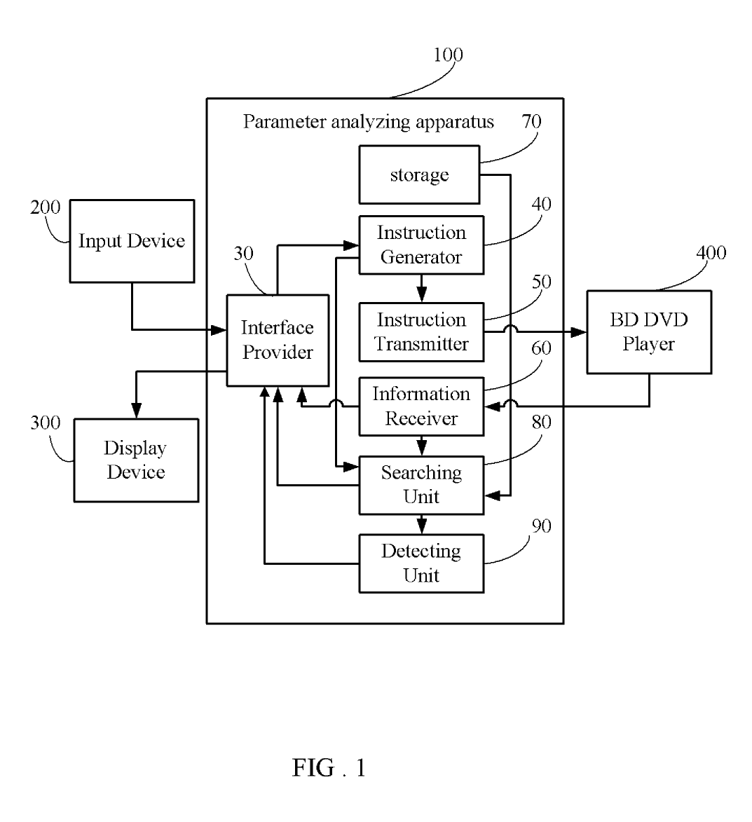

Referring to FIG. 1, a parameter analyzing apparatus 100 analyzes parameters set in an electronic device, such as television, DVD player, notebook, computer, for example. In this embodiment, a BD DVD player 400 is used as an example. The parameter analyzing apparatus 100 is capable of analyzing the parameters set in the BD DVD player 400 to know functions of the BD DVD player 400. The parameter analyzing apparatus 100 may be software or firmware installed in a computer. The parameter analyzing apparatus 100 cooperates with an input device 200 and a display device 300 connected to the BD DVD player 400 to analyze the parameters of the BD DVD player 400. The input device 200 may be a keyboard, a mouse, a touch screen, for example. The display device 300 may be a LCD display, a LED display, for example.

The parameter analyzing apparatus 100 transmits instructions to the BD DVD player 400 and receives parameters from the BD DVD player 400 according to the instructions. The parameter analyzing apparatus 100 includes an interface provider 30, an instruction generator 40, an instruction transmitter 50, an information receiver 60, a storage 70, a searching unit 80, and a detecting unit 90.

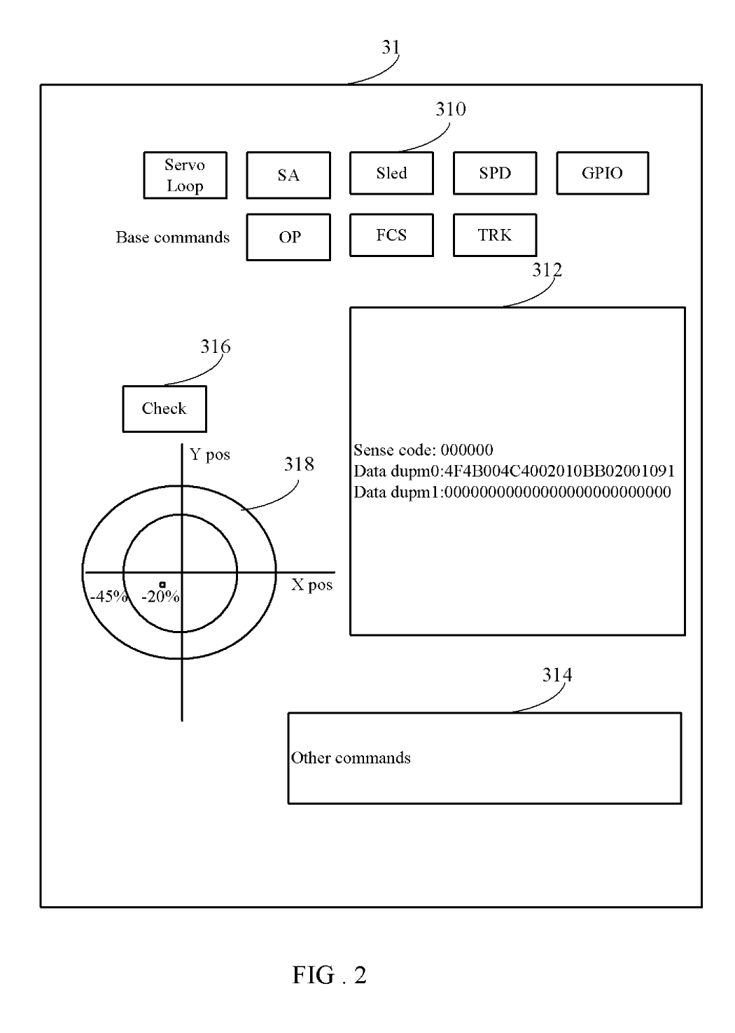

Referring to FIG. 2, the interface provider 30 provides a user interface 31 and the user interface 31 is displayed on the display device 300. The user interface 31 includes a plurality of icons 310, an information region 312, and an instruction box 314. The plurality of icons 310 are activated to generate commands from a user. For example, a user can click anyone of the plurality of icons 310 with the input device 200 to activate the icon 310. The information region 312 shows parameters from the BD DVD player 400. The instruction box 314 inputs commands from a user. For example, a user can input the commands with the input device 200. In this embodiment, the commands from the user, which are high use probability, are set as icons 310. For example, the icons 310 can be named according to the commands from the user. The user inputs instructions, which are low use probability, in to the instruction box 314.

The instruction generator 40 generates instructions in response to the commands from the user, and the instructions are transmitted to the BD DVD player 400 via the instruction transmitter 50.

The information receiver 60 receives the parameters generated by the BD DVD player according to the generated instructions.

The storage 70 stores a plurarity of predetermined keywords, the plurarity of the predetermined keywords are in accordance with the instructions which are corresponding to the plurarity of the icons 310.

The searching unit 80 calls a corresponding predetermined keyword from the storage 70, and searches the received parameters for desired parameters matching with the corresponding keyword in response to the instructions. The corresponding parameters are shown on the information regions 312.

The interface provider 30 provides a detecting icon 316 if the parameters are shown on the information regions 312. The detecting icon 316 is activated by the user to generate a detecting command

The detecting unit 90 detects the desired parameters, and generates a detecting result to display on the user interface 31 in response to the detecting command For example, The detecting unit 90 compares the desired parameters with predetermined parameters to determine whether the desired parameters meet a requirement. The detecting result may be shown as graphics.

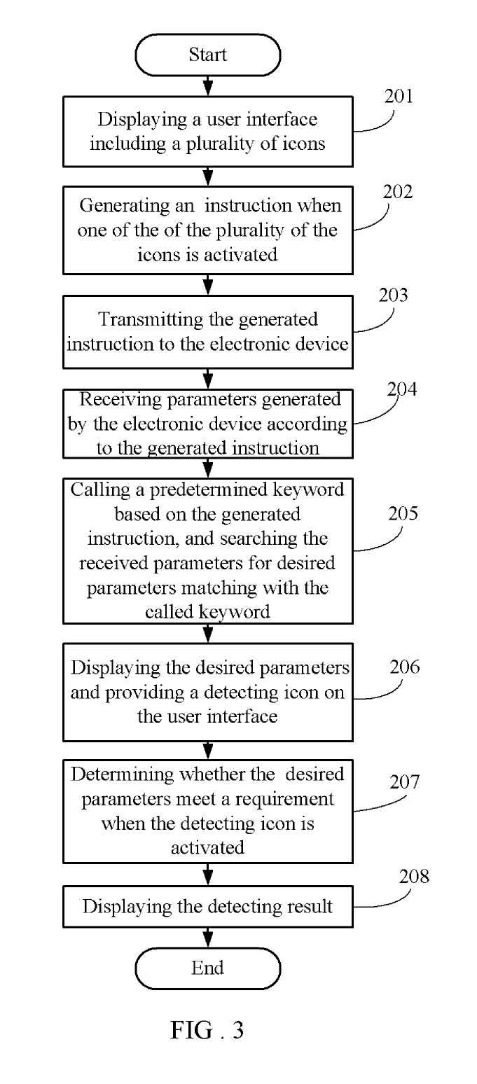

Referring to FIG. 3, the parameter analyzing method for analyzing the parameters set in an electronic device includes the following steps.

In step 201, displaying a user interface including a plurality of icons.

In step 202, generating an instruction when one of the of the plurality of icons is activated.

In step 203, transmitting the instruction to the electronic device.

In step 204, receiving parameters generated by the electronic device according to the instruction.

In step 205, calling a predetermined keyword based on the instruction, and searching the received parameters for desired parameters matched with the predetermined keyword.

In step 206, displaying the desired parameters and providing a detecting icon on the user interface.

In step 207, detecting whether the desired parameters meet a requirement when the detecting icon is activated. For example, it is determined whether the desired parameters meet the requirement by comparing the desired parameters with predetermined parameters.

In step 208, displaying the detecting result. In this embodiment, the detecting result is shown as graphics.

As described above, the parameter analyzing apparatus 100 and parameter analyzing method provide a user interface 31 having the icons 310 to be activated to generate corresponding instructions, and it is convenient for the user. Further, the parameter analyzing apparatus 100 and parameter analyzing method are capable of automatically and rapidly searching for the desired parameters based on the predetermined keywords. Moreover, the parameter analyzing apparatus 100 and parameter analyzing method are capable of detecting whether the parameters set in the BD DVD player 400 meet a requirement and showing the detecting result as graphics.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A parameter analyzing apparatus for analyzing parameters set in an electronic device, comprising:
an interface provider to provide a user interface to a display device connected to the electronic device and control the display device to display the user interface, the user interface comprising a plurality of icons capable of being activated to generate commands from a user;
an instruction generator to generate instructions in response to the commands from the user;
an instruction transmitter to transmit the generated instructions to the electronic device;
an information receiver to receive the parameters which are generated by the electronic device according to the generated instructions; and
a detecting unit comparing the received parameters with a predetermined parameters to determined whether the parameters meet a requirement.

2. The parameter analyzing apparatus of claim 1, further comprising a searching unit to search the received parameters for desired parameters based on one of a plurality of predetermined keywords.

3. The parameter analyzing apparatus of claim 2, further comprising a storage to store the plurality of predetermined keywords which are in accordance with the plurality of icons, the searching unit capable of calling one of the plurality of predetermined keywords to search for desired parameters matched with the called predetermined keyword in response to the generated instructions.

4. The parameter analyzing apparatus of claim 2, wherein the detecting unit detects whether the desired parameters meets the requirement, and generates a detecting result and the detecting result is displayed on the display device.

5. The parameter analyzing apparatus of claim 4, wherein the detecting result is displayed as graphics.

6. The parameter analyzing apparatus of claim 1, wherein the electronic device is a Blue Ray Disc (BD) DVD player.

7. A parameter analyzing method for analyzing parameters set in an electronic device, comprising:
displaying a user interface having a plurality of icons to be activated to generate commands from a user;
generating instructions in response to the commands;
transmitting the instructions to the electronic device; receiving the parameters generated by the electronic device according to the instructions; and
detecting whether the received parameters meet a requirement by comparing the received parameters with predetermined parameters.

8. The parameter analyzing method of claim 7, wherein after receiving the parameters, the parameter analyzing method further comprising:
searching the receiving parameters for desired parameters based on one of a plurality of predetermined keywords in accordance with the instructions.

9. The parameter analyzing method of claim 8, wherein after searching for the parameters, the parameter analyzing method comprising:
detecting whether the searched desired parameters meet the requirement, and displaying the detecting result.
